(19) United States
(12) Patent Application Publication
(10) Pub. No.: US 2018/0058112 A1
(43) Pub. Date: Mar. 1, 2018

(54) VEHICLE DOOR CLOSING AND RELEASING APPARATUS

(71) Applicant: AISIN TECHNICAL CENTER OF AMERICA, INC., Northville, MI (US)

(72) Inventor: Emiko OKUMA, Novi, MI (US)

(73) Assignee: AISIN TECHNICAL CENTER OF AMERICA, INC., Northville, MI (US)

(21) Appl. No.: 15/253,937

(22) Filed: Sep. 1, 2016

(51) Int. Cl. E05B 81/90; E05B 81/16; E05B 81/36; E05B 83/18

(52) U.S. Cl. CPC E05B 81/90; E05B 81/16; F16H 37/122; E05B 83/18; E05B 81/36

(57) ABSTRACT

A closing-releasing apparatus for a door of a vehicle including a lock assembly to unlatch, partially latch, and fully latch the door; a close release assembly to articulate the lock assembly, the close release assembly having an active lever that rotates around an active lever axis, a cancel gear slidably affixed to the active lever, a passive lever disengageably affixed to the cancel gear and that articulates the link lever, an open lever disengageably affixed to the passive lever that rotates around the active lever axis to articulate the lift lever, and a cancel lever configured to disengage the passive lever from the cancel gear and to disengage the open lever from the passive lever when activated; a drive assembly to drive the active lever in normal mode of operations; and a manual actuator to activate the cancel lever and by-pass the active lever in emergency manual mode of operations.

### BACKGROUND

### Field of the Disclosure

The present disclosure relates to a vehicle door closing and releasing apparatus.

### Description of the Related Art

Conventional locking mechanisms for a vehicle door rely on latch-and-pawl mechanisms to lock, restrict, and release a latch from holding a striker of the door. As a result, the door can be articulated in different predetermined states, for example, a fully-latched state, a partially-latched state, or an unlatched state.

Such conventional locking mechanisms may also sue vehicle door opening/closing mechanisms driven by electrical motors to articulate and place the door in the fully-latched state, partially-latched state, and the unlatched state.

For the above-mentioned type of vehicle door opening/closing mechanism, in the case where the electric motor fails, e.g. motor griping or energy failure, and when the locking mechanism is in the fully-latched state, or in the unlatched state, the latch can be stuck in the fully-latched state or in the unlatched state preventing the door from being closed or open.

Thus, a vehicle door opening/closing mechanism having the ability to cancel or overcome the blockage of the door in the fully latched state or unlatched state is desired.

Several vehicle door opening/closing devices having cancel functions to cancel or overcome the blockage of the door in the fully latched state or unlatched state have been disclosed. However, for such vehicle door opening/closing devices the cancel functions are performed by a complex canceling mechanism that rely on a plurality of parts with complex interactions between each other.

For example, in U.S. Pat. No. 8,894,103 B2, a door opening/closing device is disclosed having a canceling mechanism with a positioning lever, a relay lever, a release lever, a release cancel cable and a release cable connecting and articulating each other and placed peripherally to an active lever.

Therefore, a vehicle door opening/closing device configured to avoid the above-mentioned disadvantages is desired.

### SUMMARY

Accordingly, the object of the present disclosure is to provide an apparatus for closing and releasing a door of a vehicle which improves known mechanisms. The vehicle door closing and releasing apparatus of the present disclosure ensures compactness, reliability and cost effectiveness due to a configuration that controls the engagement/disengagement between an active lever, a passive lever, and an open lever via one cancel lever, to by-pass a drive system and articulate a latch of a vehicle door.

Such a configuration positions the active lever, the passive lever, the open lever, and the cancel lever on top of each other to form a compact assembly with direct interactions between each other.

In addition, in this compact assembly, the passive lever is placed coaxially with the active lever and the engagement/disengagement between the passive lever and the active lever is assured by a cancel gear directly supported by the active lever, which is itself directly connected to a drive system.

In one non-limiting illustrative example, a door closing-releasing apparatus for a door of a vehicle is presented. The door closing-releasing apparatus includes a lock assembly having a latch lever configured to unlatch, partially latch, and fully latch the door, a lift lever with a pawl to lock the latch lever, and a link lever to articulate the latch lever; a close release assembly configured to articulate the lift lever and the link lever, the close release assembly having an active lever that rotates around an active lever axis, a cancel gear slidably affixed to the active lever, a passive lever disengageably affixed to the cancel gear and that articulates the link lever, an open lever disengageably affixed to the passive lever that rotates around the active lever axis to articulate the lift lever, and a cancel lever configured to disengage the passive lever from the cancel gear and to disengage the open lever from the passive lever when activated; a drive assembly configured to drive the active lever in normal mode of operations; and a manual actuator configured to activate the cancel lever and by-pass the active lever in emergency manual mode of operations.

In another non-limiting illustrative example, a close release assembly to articulate a lock assembly of a door of a vehicle is presented. The close release assembly includes an active lever that rotates around an active lever axis; a cancel gear slidably affixed to the active lever; a passive lever disengageably affixed to the cancel gear and that articulates the lock assembly; an open lever disengageably affixed to the passive lever that articulates the lock assembly; and a cancel lever configured to disengage the passive lever from the cancel gear and to disengage the open lever from the passive lever when the active lever fails to rotate.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A is a back perspective view of a vehicle with a door, according to certain aspects of the disclosure;

FIG. 1B is a perspective view of the door with a door closing-releasing apparatus, according to certain aspects of the disclosure;

FIG. 1C is a cross sectional view of the door closing-releasing apparatus, according to certain aspects of the disclosure;

FIG. 2 is an exploded view of the door closing-releasing apparatus, according to certain aspects of the disclosure;

FIG. 3A is a top view of a latch lever with a lift lever of the door closing-releasing apparatus, according to certain aspects of the disclosure;

FIG. 3B is a side view of the latch lever with the lift lever of the door closing-releasing apparatus, according to certain aspects of the disclosure;

FIG. 3C is a top view of the latch lever with a link lever of the door closing-releasing apparatus, according to certain aspects of the disclosure;

FIG. 3D is a side view of the latch lever with the link lever of the door closing-releasing apparatus, according to certain aspects of the disclosure;

FIG. 4A is a top view of the latch lever of the door closing-releasing apparatus in a unlatched state, according to certain aspects of the disclosure;

FIG. 4B is a top view of the latch lever of the door closing-releasing apparatus in a half latched state, according to certain aspects of the disclosure;

FIG. 4C is a top view of the latch lever of the door closing-releasing apparatus in a full latched state, according to certain aspects of the disclosure;

FIG. 5A is an exploded view of a close-release assembly, according to certain aspects of the disclosure;

FIG. 5B is a side view of the close-release assembly, according to certain aspects of the disclosure;

FIG. 5C is a front view of the close-release assembly, according to certain aspects of the disclosure;

FIG. 6A is a front view of the close-release assembly in the half latched state during a normal latching mode of operation, according to certain aspects of the disclosure;

FIG. 6B is a front view of the close-release assembly in an intermediate normal latching state during the normal latching mode of operation, according to certain aspects of the disclosure;

FIG. 6C is a front view of the close-release assembly in the full latched state during the normal latching mode of operation, according to certain aspects of the disclosure;

FIG. 7A is a front view of the close-release assembly in the full latched state during an emergency manual unlatching mode of operation, according to certain aspects of the disclosure;

FIG. 7B is a front view of the close-release assembly in an intermediate emergency manual unlatching state during the emergency manual unlatching mode of operation, according to certain aspects of the disclosure;

FIG. 7C is a front view of the close-release assembly in the cancelled unlatched state during the emergency manual unlatching mode of operation, according to certain aspects of the disclosure;

FIG. 8A is a front view of the close-release assembly in the neutral state during a normal unlatching mode of operation, according to certain aspects of the disclosure;

FIG. 8B is a front view of the close-release assembly in the unlatched state during the normal unlatching mode of operation, according to certain aspects of the disclosure;

FIG. 9A is a front view of the close-release assembly in the unlatched state during an emergency manual latching mode of operation, according to certain aspects of the disclosure;

FIG. 9B is a front view of the close-release assembly in an intermediate emergency manual latching state during the emergency manual latching mode of operation, according to certain aspects of the disclosure; and

FIG. 9C is a front view of the close-release assembly in the cancelled latched state during the emergency manual latching mode of operation, according to certain aspects of the disclosure.

### DETAILED DESCRIPTION

All publications, patent applications, patents, and other references mentioned herein are incorporated by reference in their entirety. Further, the materials, methods, and examples discussed herein are illustrative only and are not intended to be limiting.

The description set forth below in connection with the appended drawings is intended as a description of various embodiments of the described subject matter and is not necessarily intended to represent the only embodiment(s). In certain instances, the description includes specific details for the purpose of providing an understanding of the described subject matter. However, it will be apparent to those skilled in the art that embodiments may be practiced without these specific details. In some instances, well-known structures and components may be shown in block diagram form in order to avoid obscuring the concepts of the described subject matter. Wherever possible, the same reference numbers will be used throughout the drawings to refer to the same or the like parts.

Any reference in the specification to “one embodiment” or “an embodiment” means that a particular feature, structure, characteristic, operation, or function described in connection with an embodiment is included in at least one embodiment. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments, and it is intended that embodiments of the described subject matter can and do cover modifications and variations of the described embodiments.

It must also be noted that, as used in the specification, appended claims and abstract, the singular forms “a,” “an,” and “the” include plural referents unless the context clearly dictates otherwise. That is, unless clearly specified otherwise, as used herein the words “a” and “an” and the like carry the meaning of “one or more. ” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the described subject matter to any particular orientation or configuration. Furthermore, terms such as “first,” “second,” “third,” etc. merely identify one of a number of portions, components, points of reference, operations and/or functions as described herein, and likewise do not necessarily limit embodiments of the described subject matter to any particular configuration or orientation.

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular is also to be construed to relate to the plural and vice-versa without limiting the scope of the disclosure to the exact number or type of such elements unless set forth explicitly in the appended claims.

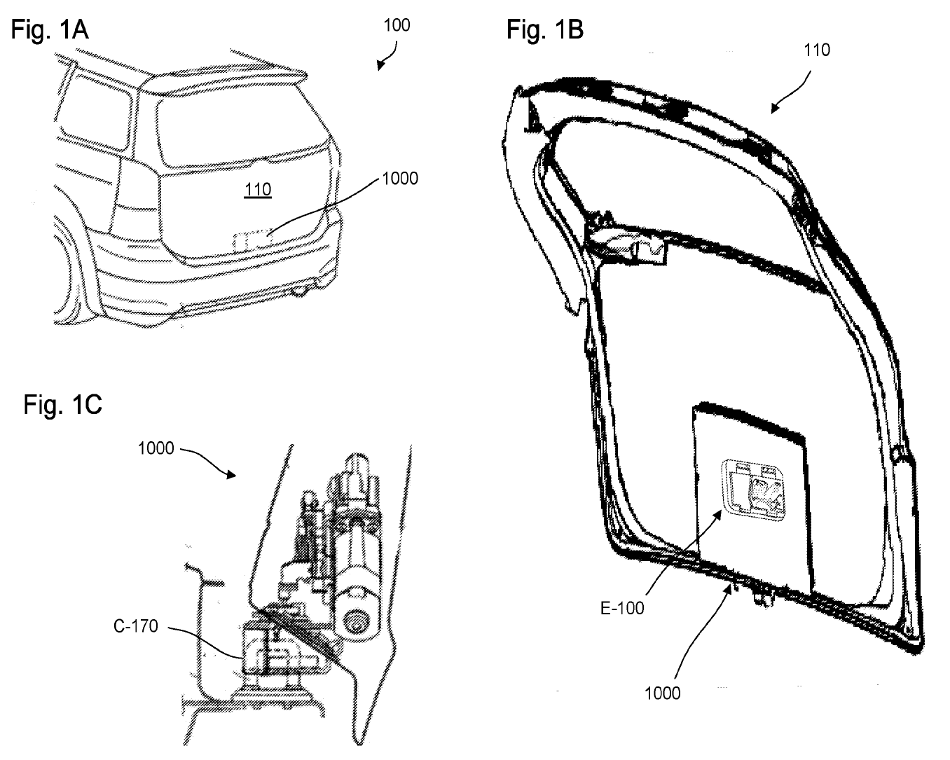

FIGS. 1A-1C are a back perspective view of a vehicle 100 with a door 110, a perspective view of the door 110 with a closing-releasing apparatus 1000, and a cross sectional view of the closing-releasing apparatus 1000, respectively and according to certain aspects of the disclosure.

The closing-releasing apparatus 1000 operates the door 110 of the vehicle 100 from a full latched state, i.e. the door 110 is completely closed and fastened to the vehicle 100 via a striker C-170, or a half latched state, i.e. the door 110 is partially fastened to the vehicle 100 with some play between the striker C-170 and the door 110, to an unlatched state, i.e. the door 110 is open with the striker C-170 being free from the door 110, and vice-versa.

The closing-releasing apparatus 1000 is configured to operate the door 110 in normal mode of operations or in emergency manual mode operations when failures in the normal mode of operations happen and prevent the door 110 from being latched or unlatched. For example, such failures may be improper handlings, motor seizings or power drawings that jam the door 110 in the full latched state, the half latched state, or in the unlatched state.

In the normal mode of operations, the closing-releasing apparatus 1000 relies on power systems, e.g. a drive assembly B-100, to automatically operate the door 110 from the full latched state or the half latched state to the unlatched state, i.e. the normal latching mode of operation, or from the half latched state or the full latched state, i.e. the normal unlatching mode of operation.

In the emergency manual mode of operations, the closing-releasing apparatus 1000 relies on manual operations, e.g. via an actuator assembly E-100, to by-pass the power systems and manually operate the door 110 from the full latched state or the half latched state to the unlatched state, i.e. the emergency manual unlatching mode of operation, or from the unlatched state to the neutral state, i.e. the emergency manual latching mode of operation.

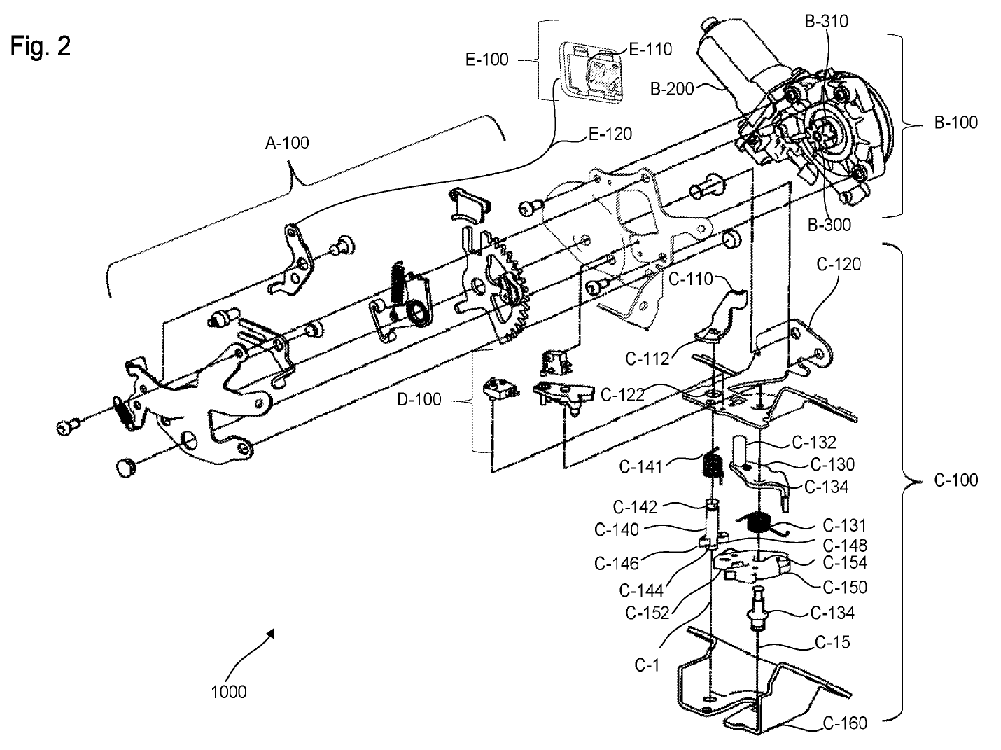

FIG. 2 is an exploded view of the door closing-releasing apparatus 1000, according to certain aspects of the disclosure.

The closing-releasing apparatus 1000 includes a close-release assembly A-100, the drive assembly B-100, a lock assembly C-100, a switch assembly D-100, and the actuator assembly E-100.

In the normal mode of operations, the drive assembly B-100 drives the close-release assembly A-100, while in the emergency manual mode of operations, the actuator assembly E-100 articulates the close-release assembly A-100 and by-passes the drive assembly B-100. For both the normal mode of operations and emergency manual mode of operations, the close-release assembly A-100 operates the lock assembly C-100, via the switch assembly D-100, to articulate the door 110 in the unlatched state, the half latched state, and the unlatched state.

The drive assembly B-100 may include a motor B-200, e.g. an electrical motor and/or pneumatic motor, to drive a drive shaft B-300 with a pinion B-310 connected to the close-release assembly A-100.

The actuator assembly E-100 may include a manual actuator E-110, e.g. a handle or a trigger, to actuate a linkage E-120, e.g. cables or connecting rods, connected to the close-release assembly A-100.

The lock assembly C-100 may include a lift lever C-110, a lock support C-120, a link lever C-130 with a pin C-132, a pawl C-140, a latch lever C-150, and a lock base C-160.

The pawl C-140 with the lift lever C-110 are rotably affixed to the lock support C-120, the link lever C-130 with the pin C-132 are rotably affixed to the lock support C-120, and the latch lever C-150 is rotably affixed to the lock base C-160.

The pawl C-140 may have a first extremity C-142 that goes through a pawl hole C-122 of the lock support C-120 and inserts in a key hole C-112 of the lift lever C-110.

The pawl C-140 may have a second extremity C-144 with a first radial protrusion C-146 and a second radial protrusion C-148. The first radial protrusion C-146 and the second radial protrusion C-148 may push the latch lever C-150 to articulate the lock assembly C-100 in the half latched state, the full latched state, and the unlatched state.

The pawl C-140 may articulate the latch lever C-150 via a bias force exerted by a spring C-141 affixed to the lock support C-120 and at least one of the first radial protrusion C-146 and the second radial protrusion C-148.

The link lever C-130 may be rotably affixed to the lock support C-120 via a pivot C-134 supported on one extremity by the lock base C-160 and on another extremity by the switch assembly D-100, and inserted through the latch lever C-150, the link lever C-130, and the lock support C-120.

The pin C-132 may protrude vertically from a first extremity of the link lever C-130 and point towards the lock support C-120 to be in contact with the close-release assembly A-100.

The link lever C-130 may articulate the latch lever C-150 via a bias force exerted by a supplementary spring C-131 affixed to the link lever C-130 and the latch lever C-150.

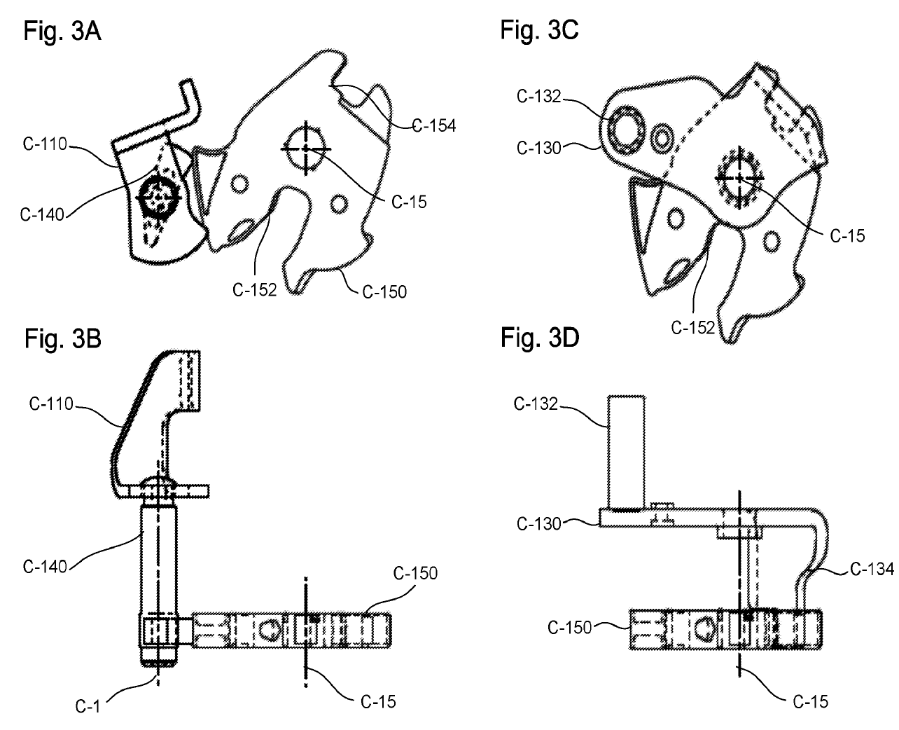

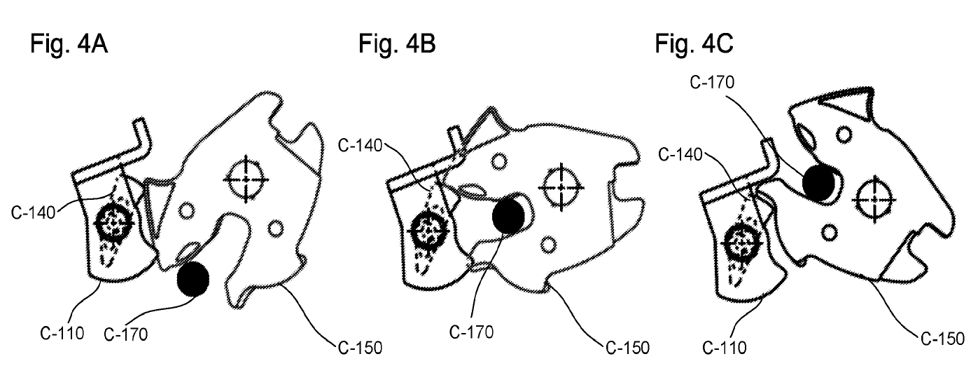

FIGS. 3A-3D are a top view of the latch lever C-150 with the lift lever C-110, a side view of the latch lever C-150 with the lift lever C-110, a top view of the latch lever C-150 with the link lever C-130, and a side view of the latch lever C-150 with the link lever C-130, respectively and according to certain aspects of the disclosure. FIGS. 4A-4C are top views of the closing-releasing apparatus 1000 in the unlatched state, the half latched state, and the full latched state, respectively and according to certain aspects of the disclosure.

The pawl C-140 with the lift lever C-110 and the link lever C-130 with the pin C-132 articulate the latch lever C-150 around the striker C-170 to place and maintain the lock assembly C-100 in the half latched state, the full latched state, and the unlatched state.

The lift lever C-110 and the pawl C-140 are clinched together and rotate around a lift lever axis C-1. The rotation of the pawl C-140 is configured to maintain the latch lever C-150 in the half latched state, i.e. the striker C-170 is partially inserted into a latch lever slot C-152 of the latch lever C-150 as illustrated in FIG. 4B, and the full latched state, i.e. the striker C-170 is completely inserted into the latch lever slot C-152 as illustrated in FIG. 4C.

The rotation of the lift lever C-110 and the pawl C-140 is configured to release the latch lever C-150 from the full latched state or half latched state to the unlatched state, i.e. the striker C-170 is disengaged from the latch lever slot C-152, as illustrated in FIG. 4A.

The pivot C-134 of the link lever C-130 is inserted into a key seat C-154 of the latch lever C-150 to rotate the link lever C-130 and the latch lever C-150 around a latch lever axis C-15. The rotation of the latch lever C-150 by the link lever C-130 is configured to engage and disengage the striker C-170 into and from the latch lever slot C-152.

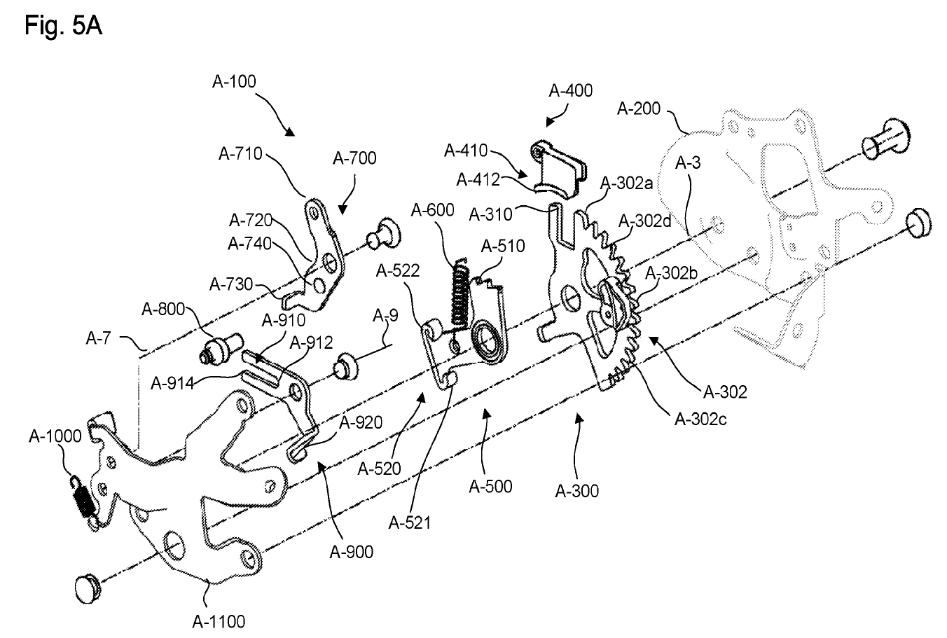

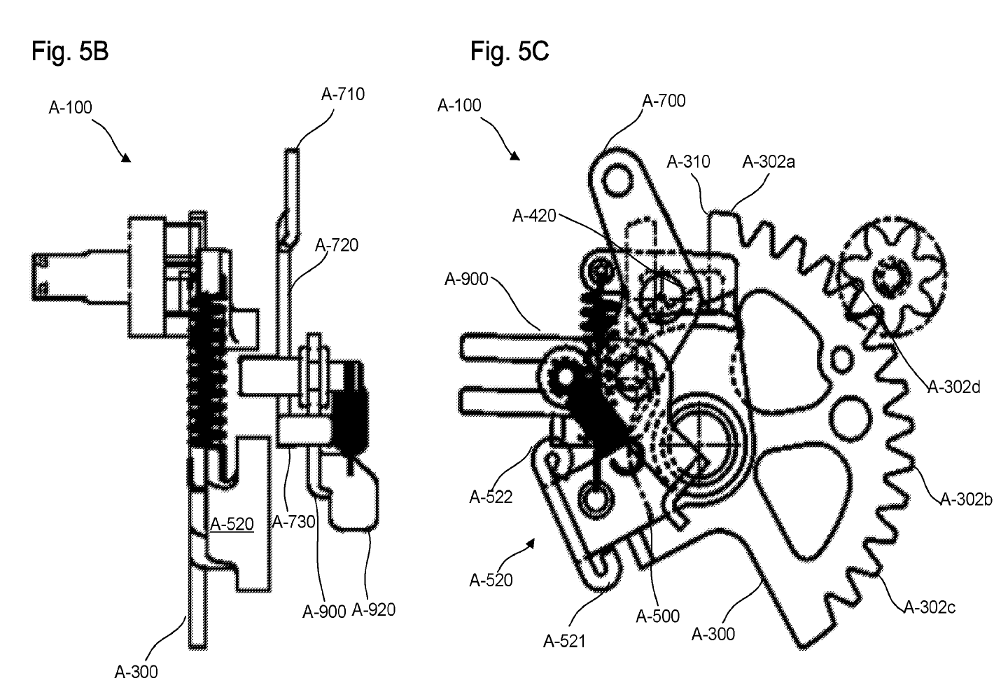

FIGS. 5A-5C are an exploded view, a side view, and a front view of the close-release assembly A-100, respectively and according to certain aspects of the disclosure.

The close-release assembly A-100 includes a base plate A-200, an active lever A-300 connected to the pinion B-310 of the drive assembly B-100, a cancel gear A-400, a passive lever A-500, a cancel spring A-600, a cancel lever A-700 connected to the linkage E-120 of the actuator assembly E-100, a cancel slide pin A-800, an open lever A-900, an open spring A-1000, and a bracket A-1100.

The active lever A-300 is rotably affixed on the base plate A-200 to rotate around an active lever axis A-3 in counter-clockwise direction and a clockwise direction through the action of the drive assembly B-100, in the normal mode of operations. The rotation of the active lever A-300 by the drive assembly B-100 is performed by a plurality of teeth A-302 placed on a peripheral surface of the active lever A-300 and in contact with the pinion B-310 of the drive assembly B-100. The plurality of teeth A-302 includes a neutral tooth A-302d, an unlatch tooth A-302a located at a first circumferential extremity of the active lever A-300, a full latch tooth A-302c located at a second circumferential extremity of the active lever A-300, and a half latch tooth A-302b located between the neutral tooth A-302d and the full latch tooth a-302c at a predetermine distance from the neutral tooth A-302d.

The peripheral surface of the active lever A-300 includes an active lever slot A-310 that may be located adjacently to the unlatch tooth A-302a and that is configured to receive the cancel gear A-400.

The cancel gear A-400 includes a cancel gear wall A-410 with a curved contact surface A-412, e.g. an arc of a circle, facing the active lever axis A-3 and a cancel gear ratchet A-420 having a castellated shape, e.g. a saw tooth shape.

The cancel gear A-400 is inserted in the active lever slot A-310 and configured to slide along a length of the active lever slot A-310 with the cancel gear wall A-410 and the cancel gear ratchet A-420 facing the active lever axis A-3.

The passive lever A-500 is rotably affixed to the active lever A-300 and rotates around the active lever axis A-3.

The passive lever A-500 may have a L-shape with a first extremity ended by a passive lever ratchet A-510 and a second extremity ended by a bumper A-520 with a first hammer A-521 and a second hammer A-522.

The passive lever ratchet A-510 is configured to match the cancel gear ratchet A-420 and engage onto the cancel gear A-400 to lock the passive lever A-500 into the cancel gear A-400. The first hammer A-521 is configured to contact and push the pin C-132 of the link lever C-130, and the second hammer A-522 is configured to contact the cancel slide pin A-800.

The cancel spring A-600 is affixed to the passive lever A-500 and the cancel gear A-400 to push the passive lever A-500 and the cancel gear A-400 against each other.

The passive lever A-500 rotates with the active lever A-300 when the passive lever ratchet A-510 is engaged into the cancel gear ratchet A-420, while the passive lever A-500 rotates independently from the active lever A-300 when the passive lever ratchet A-510 is disengaged from the cancel gear ratchet A-420.

The cancel lever A-700 is rotably affixed to a first extremity of the bracket A-1100 to rotate around a cancel lever axis A-7 substantially parallel to the active lever axis A-3 and located above the cancel gear wall A-410.

The open lever A-900 is inserted between the cancel lever A-700 and the bracket A-1100 and rotably affixed to a second extremity of the bracket A-1100 to rotate around an open lever axis A-9 substantially parallel to the active lever axis A-3 and located between the cancel lever axis A-7 and the active lever axis A-3.

The open lever A-900 includes an open lever slot A-910 and an open lever hook A-920.

The open lever slot A-910 extends radially from a closed end A-912, located near the open lever axis A-9, to an open end A-914, located at a periphery of the open lever A-900. The open lever slot A-910 is configured to receive the cancel slide pin A-800 and let the cancel slide pin A-800 slide along a length of the open lever slot A-910.

The open lever hook A-920 protrudes radially from the open lever A-900 and is configured to contact and push the lift lever C-110.

The cancel lever A-700 includes a first extremity A-710 connected to the linkage E-120 of the actuator assembly E-100 to be manually triggered in the emergency manual mode of operations, a second extremity A-730 to be in contact in contact with the open lever A-900 and rotate the open lever A-900, and a middle part A-720 to be in contact with the cancel slide pin A-800 and slide the cancel slide pin A-800 along the length of the open lever slot A-910.

The first extremity A-710 may be anchored to a cable of the linkage E-120, the middle part A-720 may have a step profile to push the cancel slide pin A-800 along the open lever slot A-910, and the second extremity A-730 may have a protrusion extended outwardly from the cancel lever A-700 to grab the open lever A-900.

The cancel slide pin A-800 is maintained against the closed end A-912 of the open lever A-900 via a bias force exerted by the open spring A-1000 affixed to the bracket A-1100 and the cancel slide pin A-800.

When the cancel lever A-700 is triggered and rotates the middle part A-720 pushes the cancel slide pin A-800 away from the closed end A-912 of the open lever slot A-910 along the length of the open lever slot A-910, the second hammer A-522 of the passive lever A-500 fits between the closed end A-912 and the cancel slide pin A-800, and the second extremity A-730 of the cancel lever A-700 enters into contact with the open lever A-900 and forces the open lever A-900 to rotate.

In addition, the cancel lever A-700 includes a protrusion A-740 that protrudes substantially perpendicular from the cancel lever A-700 towards the cancel gear A-400. The protrusion A-740 is located between the second extremity A-730 and the middle part A-720 at a predetermined distance from the cancel lever axis A-7 to follow the curved contact surface A-412 of the cancel gear wall A-410 when the cancel lever A-700 is rotated.

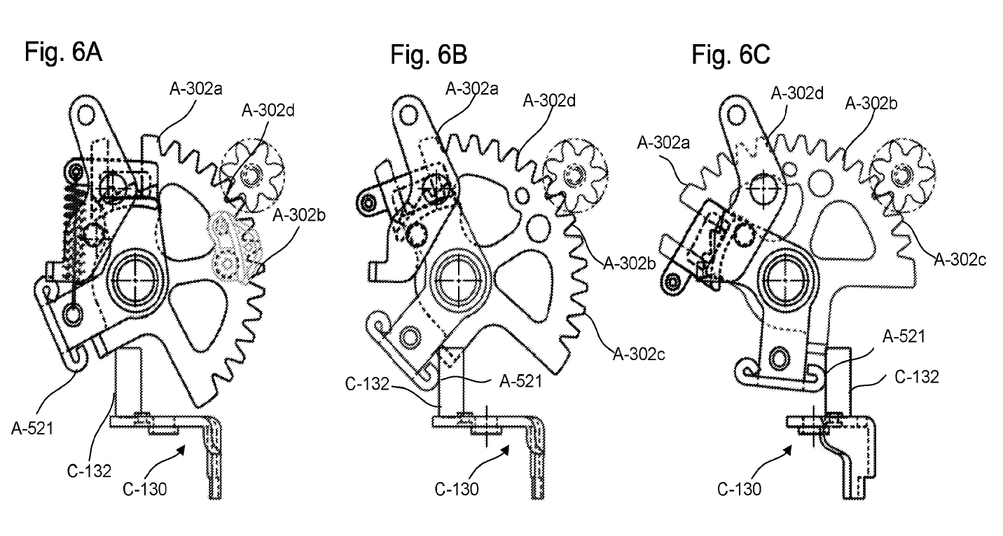

FIGS. 6A-6C are a front view of the close-release assembly A-100 in the half latched state, in an intermediate normal latching state, and in the full latched state during the normal latching mode of operation, respectively and according to certain aspects of the disclosure.

In the normal latching mode of operation, the close-release assembly A-100 is articulated from the half latched state, as illustrated in FIG. 6A, to the fully latched state, as illustrated in FIG. 6C, through the action of the drive assembly B-100.

In the half latched state, the pinion B-310 is positioned on the half latch tooth A-302b of the plurality of teeth A-302 and the link lever C-130 of the lock assembly C-100 is maintained partially extended by the pawl C-140 of the lock assembly C-100, as illustrated in FIG. 4B.

In the full latched state, the pinion B-310 is positioned on the full latch tooth A-302c of the plurality of teeth A-302 and the first hammer A-521 of the passive lever A-500 contacts the pin C-132 of the link lever C-130 to maintain the link lever C-130 contracted, and the latch lever C-150 is engaged into the striker C-170 of the vehicle 100, as illustrated in FIG. 4C.

When the pinion B-310 of the drive assembly B-100 rotates in the clockwise direction, the active lever A-300 rotates in the counter-clockwise direction from the half latched tooth A-302b to the full latch tooth A-302c, around the active lever axis A-3. The passive lever A-500, engaged to the active lever A-300 via the cancel gear A-400, rotates with the active lever A-300 in the counter-clockwise direction from the half latched tooth A-302b to the full latch tooth A-302c, around the active lever axis A-3.

The counter-clockwise rotation of the passive lever A-500 forces the first hammer A-521 to contact the pin C-132 of the link lever C-130 and folds the link lever C-130 from partially extended to contracted.

The folding of the link lever C-130 articulates the latch lever C-150 to engage the striker C-170 of the vehicle 100, i.e. fully latch the door 110 onto the vehicle 100.

In the normal mode of operations, when the switch assembly D-100 detects the fully latched state, the pinion B-310 rotates in the counter-clockwise direction and returns to the neutral state on the neutral latch tooth A302d of the plurality of the teeth A302, and the first hammer A-512 of the passive lever A-500 releases from the contact with the pin C-132 of the link lever C-130, while the latch lever C-150 and the striker C-170 stays engaged by the pawl C-140, as illustrated in FIG. 4C.

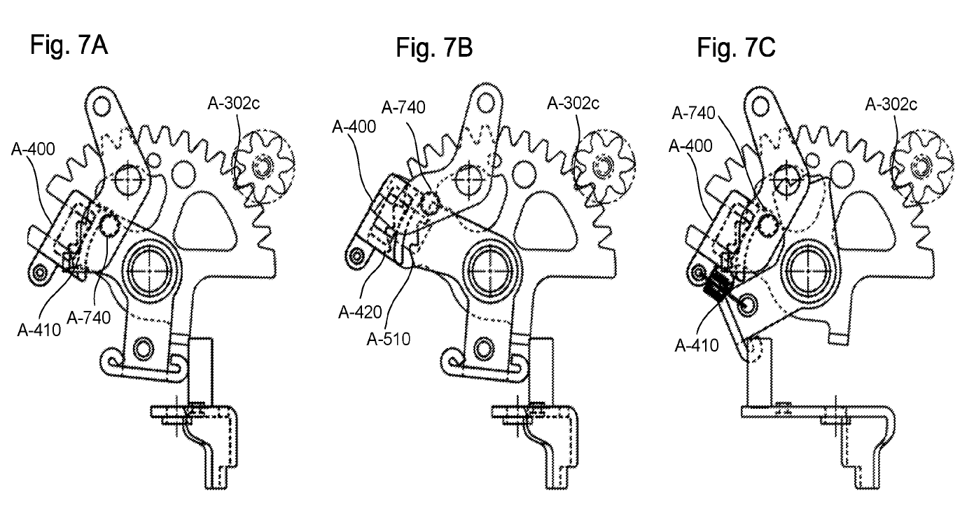

FIGS. 7A-7B are a front view of the close-release assembly A-100 in the full latched state, an intermediate emergency manual unlatching state, and the unlatched state during the emergency manual unlatching mode of operation, respectively and according to certain aspects of the disclosure.

In the emergency manual unlatching mode of operation, the close-release assembly A-100 is articulated from the fully latched state, as illustrated in FIG. 7A, to the unlatched state, as illustrated in FIG. 7C, through the action of the cancel lever A-700. The emergency manual unlatching mode of operation is particularly relevant when failures happen in the drive assembly B-100, e.g. seized motor, or power failure, and the door 110 needs to be unlatched.

When the cancel lever A-700 is pulled, via the actuator assembly, to rotate around the cancel lever axis A-7, the protrusion A-740 of the cancel lever A-700 contacts the curved contact surface A-412 of the cancel gear wall A-410 and forces the cancel gear A-400 to slide along the length of the active lever slot A-310 to disconnect the cancel gear ratchet A-420 from the passive lever ratchet A-510. The disconnection between the cancel gear ratchet A-420 and the passive lever ratchet A-510 disengages the passive lever A-500 from the active lever A-300.

Once the passive lever A-500 is disengaged from the active lever A-300, the passive lever A-500 can rotate in the clockwise direction via a bias force exerted by the cancel spring A-600. The rotation of the passive lever A-500 enables the lift lever C-110 to be articulated back to the unlatched state and disengages the latch lever C-150 from the striker C-170 to unlatch the door 110, as illustrated in FIG. 4A.

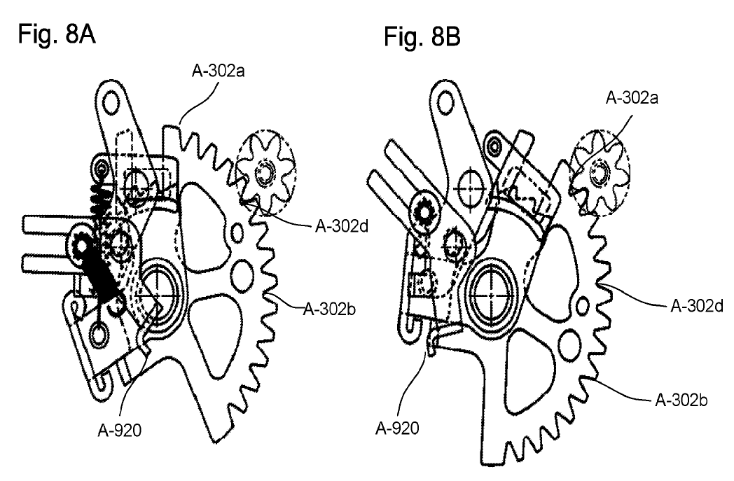

FIGS. 8A-8B are a front view of the close-release assembly A-100 in the neutral state and the unlatched state during the normal unlatching mode of operation, respectively and according to certain aspects of the disclosure.

In the normal unlatching mode of operation, the close-release assembly A-100 is articulated from the neutral state, as illustrated in FIG. 8A, to the unlatched state, as illustrated in FIG. 8B, through the action of the drive assembly B-100. In the unlatched state, the pinion B-310 is positioned on the unlatch tooth A-302a of the plurality of teeth A-302, the second hammer A-522 of the passive lever A-500 is in contact with the cancel slide pin A-800 and the open lever A-900. The open lever hook A-920 contacts the lift lever C-110 to disengage the pawl C-140 from the latch lever C-150 and disengage the latch lever C-150 from the striker C-170 of the vehicle 100, as illustrated in FIG. 4A.

When the pinion B-310 of the drive assembly B-100 rotates in the counter-clockwise direction, the active lever A-300 rotates in the clockwise direction from the neutral tooth A-302d to the unlatched tooth A-302a around the active lever axis A-3. The passive lever A-500, engaged to the active lever A-300 via the cancel gear A-400, rotates with the active lever A-300 in the clockwise direction from the neutral tooth A-302d to the unlatched tooth A-302a around the active lever axis A-3.

The clockwise rotation of the passive lever A-500 forces the second hammer A-522 of the passive lever A-500 to contact the cancel slide pin A-800 and rotate the open lever A-900 around the open lever axis A-9 in the clockwise direction. The rotation of the open lever A-900 in the clockwise direction forces the open lever hook A-920 to contact the lift lever C-110 and forces the lift lever C-110 to rotate with the pawl C-140. The rotation of the lift lever C-110 with the pawl C-140 disengages the latch lever C-150 from the striker C-170 and unlatches the door 110, as illustrated in FIG. 4A.

In the normal mode of operations, when the switch assembly D-100 detects the unlatched state, the pinion B-310 rotates in the clockwise direction and returns to the neutral state on the neutral latch tooth A-302d of the plurality of the teeth A-302, and the second hammer A-522 of the passive lever A-500 releases from the contact with the cancel slide pin A-800 to be articulated to the neutral state, as illustrated in FIG. 8A.

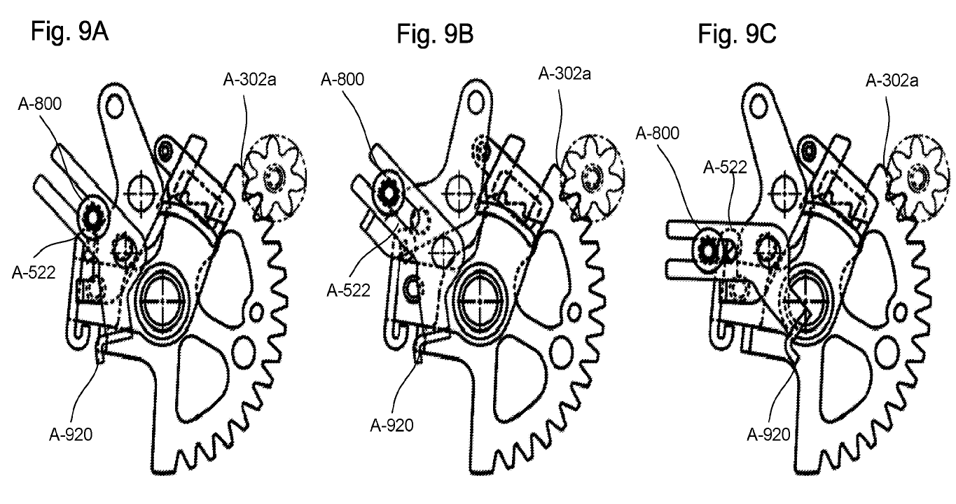

FIGS. 9A-9C are a front view of the close-release assembly A-100 in the unlatched state, an intermediate emergency manual latching state, and the cancelled state, respectively and during a emergency manual latching mode of operation, according to certain aspects of the disclosure.

In the emergency manual latching mode of operation, the close-release assembly A-100 is articulated from the unlatched state, as illustrated in FIG. 9A, to the cancelled state, as illustrated in FIG. 9C, through the action of the cancel lever A-700. The emergency manual latching mode of operation is particularly relevant when failures happen in the drive assembly B-100 and the door 110 needs to be latched.

When the cancel lever A-700 is pulled, via the actuator assembly E-100, to rotate around the cancel lever axis A-7, the middle part A-720 of the cancel lever A-700 contacts the cancel slide pin A-800 and forces the cancel slide pin A-800 to slide along the open lever slot A-910 creating a space between the cancel slide pin A-800 and the closed end A-912 of the open lever A-900. The space between the cancel slide pin A-800 and the closed end A-912 disengages the open lever A-900 from the passive lever A-500.

The disengagement of the open lever A-900 from the passive lever A-500 is permitted by the insertion of the second hammer A-522 in the space between the cancel slide pin A-800 and the closed end A-912.

Once the open lever A-900 is disengaged from the passive lever A-500 and the cancel lever A-700 is released, the open lever A-900 rotates in the counter-clockwise direction via a bias force exerted by the open spring A-1000, and release the open lever hook A-920 from pushing the lift lever C-110, so that the second radial protrusion C-148 of the pawl C-140 can push the latch lever C-150 and engage each other to articulate the lock assembly C-100 in the full latch state by closing the door 110 manually.

Numerous modifications and variations on the present disclosure are possible in light of the above teachings. It is therefore to be understood that within the scope of the appended claims, the disclosure may be practiced otherwise than as specifically described herein.

What is claimed is:

1. A closing-releasing apparatus for a door of a vehicle, the closing-releasing apparatus comprising:
a lock assembly including a latch lever configured to latch the door, a lift lever to lock the latch lever, and a link lever to articulate the latch lever; and
a close release assembly configured to articulate the lift lever and the link lever, the close release assembly including:
an active lever that rotates around an active lever axis,
a cancel gear slidably affixed to the active lever,
a passive lever disengageably affixed to the cancel gear and that articulates the link lever,
an open lever disengageably affixed to the passive lever that rotates around an open lever axis to articulate the lift lever, and
a cancel lever configured to disengage the passive lever from the cancel gear and to disengage the open lever from the passive lever when activated.

2. The closing-releasing apparatus of claim 1, wherein the open lever includes an open lever slot, and a cancel slide pin slidably inserted in the open lever slot to contact the passive lever.

3. The closing-releasing apparatus of claim 2, wherein the cancel lever includes a middle part configured to slide the cancel slide pin along the open lever slot and to disengage the open lever from the passive lever.

4. The closing-releasing apparatus of claim 3, wherein the middle part of the cancel lever has a step profile.

5. The closing releasing apparatus of claim 3, wherein the passive lever include an extremity to lodge between the cancel slide pin and a closed end of the open lever slot.

6. The closing-releasing apparatus of claim 1, wherein open lever include an open lever hook to contact the lift lever.

7. The closing-releasing apparatus of claim 1, wherein the passive lever and the cancel gear are is disengageably affixed via a cancel gear ratchet of the cancel gear matching a passive lever ratchet of the passive lever.

8. The closing-releasing apparatus of claim 7, wherein the cancel lever includes a protrusion to push a curved contact surface of the cancel gear and slide the cancel gear along the active lever slot to disengage the passive lever from the active lever.

9. The closing releasing apparatus of claim 1, wherein the passive lever include a first hammer to contact and articulate the link lever.

10. The closing releasing apparatus of claim 9, wherein the passive lever include a second hammer to contact the cancel slide pin and rotate the open lever to articulate the lift lever.

11. The closing releasing apparatus of claim 1, further comprising:
a drive assembly configured to drive the active lever in a first mode of operations; and
a manual actuator configured to activate the cancel lever and by-pass the active lever in a second mode of operations.

12. A close release assembly to articulate a lock assembly of a door of a vehicle, the close release assembly comprising:
an active lever that rotates around an active lever axis;
a cancel gear slidably affixed to the active lever;
a passive lever disengageably affixed to the cancel gear and that articulates the lock assembly;
an open lever disengageably affixed to the passive lever that articulates the lock assembly; and
a cancel lever configured to disengage the passive lever from the cancel gear and to disengage the open lever from the passive lever when the active lever fails to rotate.
